(19) United States
(12) Patent Application Publication
(10) Pub. No.: US 2009/0328146 A1
(43) Pub. Date: Dec. 31, 2009

(54) Method of generating authentication code in digital device

(75) Inventor: Jong-Rae Lee, Pyeongtaek-si (KR)

Correspondence Address: HARNESS, DICKEY & PIERCE, P.L.C., P.O. BOX 8910, RESTON, VA, 20195, US

(73) Assignee: LG Electronics Inc.

(21) Appl. No.: 12/153,125

(22) Filed: May 14, 2008

(30) Foreign Application Priority Data
May 15, 2007 (KR) 10-2007-0046906

(51) Int. Cl. G06F 21/00

(52) U.S. Cl. 726/3

(57) ABSTRACT

A method of generating an authentication code in a digital device is provided. An ID set in a digital device is read when it is requested to generate an authentication code. It is determined whether the authentication code previously generated based on the ID is stored in the digital device. A new authentication code is generated based on the ID and stored when the authentication code is not stored. A part of the authentication code is displayed. Only the serial number can be displayed in the authentication code. The ID is a unique and fixed value set when the digital device is produced. And, the ID is extracted from an authentication code stored in the digital device and the extracted ID is compared with the read ID so that it is determined whether the authentication code is previously generated or is not generated yet.

This non-provisional application claims priority under 35 U.S.C. §119(a) on Patent Application No. 10-2007-0046906 filed in Republic of Korea on May 5, 2007 the entire contents of which are hereby incorporated by reference.

### BACKGROUND

1. Field

This document relates to a method of generating an authentication code in a digital device.

2. Related Art

Currently, contents information such as music, a still image, moving picture, and data is processed in a digital method and is provided to a digital device through a network such as the Internet.

In addition, the digital device such as a PC, an MP3 player, and a PMP decodes digital contents which are encoded as a digital signal and stored in a media such as a memory card, a hard disk, or an optical disc that is a non-volatile memory and outputs the decoded digital contents directly to a speaker or the screen of a liquid crystal display (LCD) that is an output device or through an external device such as a television.

An ID is recorded in the digital device or a serial number is given to a manual so that a user can easily identify the digital device. The ID or the serial number is used as a method for determining whether the digital device is an honest product when an update program related to the corresponding digital device is downloaded through the network such as the Internet. When the ID or the serial number is not correctly input, the corresponding program cannot be downloaded.

Recently, various digital contents are circulated from various contents providers (CP) through the Internet. After users access a server managed by a CP to request to buy desired digital contents, the users download the desired digital contents in various recording media such as a flash memory, a hard disk, and an optical disc to store the downloaded digital contents and reproduce the stored digital contents through digital devices if required at any time.

However, since the digital contents downloaded and stored in the various recording media can be copied and reproduced by the various digital devices, recently, in a digital contents market, an ID is provided to a digital device and digital contents such as music, moving picture, and data are encoded by an authentication code generated by the provided ID so that the digital contents can be used only by a user that buys the digital contents or a specific digital device and cannot be used by another digital device.

However, the ID or the authentication code provided to be used only by a specific user or a specific digital device is easily exposed so that the ID or the authentication code can be surreptitiously used. In addition, since the same firmware is applied to the digital device for mass production, it is difficult to transplant firmware having different authentication codes to the digital device. In addition, when an ID or a serial number is provided to the outside of the digital device, the package of the digital device, and a manual, the ID or the serial number can be exposed and there is a high probability of losing the digital device.

### SUMMARY

An aspect of this document is to provide a method of effectively generating a unique authentication code in a digital device to use the digital device.

In an aspect, a method of generating an authentication code in a digital device comprises reading an ID set in the digital device when it is requested to generate an authentication code, generating the authentication code based on the ID, and storing the authentication code and displaying a part of the authentication code.

In another aspect, a method of generating an authentication code in a digital device comprises reading an ID set in the digital device when it is requested to generate an authentication code, determining whether the authentication code previously generated based on the ID is stored in the digital device, generating a new authentication code based on the ID, storing the generated authentication code when the authentication code is not stored, and displaying a part of the authentication code.

The authentication code can be generated by combining the ID with a serial number generated using the ID. Only the serial number in the authentication code can be displayed. The ID is a unique and fixed value set when the digital device is produced.

The ID is extracted from an authentication code stored in the digital device and the extracted ID is compared with the read ID so that it is determined whether the authentication code is previously generated or is not generated yet.

A digital device comprises a memory for storing an ID set in the digital device and an authentication code and a control unit configured to read the ID set in the memory, determine whether the authentication code previously generated based on the ID is stored in the memory, generate a new authentication code based on the ID when the authentication code is not stored, store the generated authentication code in the memory, and control so that a part of the authentication code is displayed on a screen when it is requested to generate the authentication code.

### BRIEF DESCRIPTION OF THE DRAWINGS

The implementation of this document will be described in detail with reference to the following drawings in which like numerals refer to like elements.

FIG. 1 schematically illustrates the structure of a network system for describing an embodiment in which a digital device according to the present invention is connected to a contents providing server;

FIG. 2 is a block diagram schematically illustrating the structure of a digital device to which an authentication code generating method according to the present invention is applied;

FIG. 3 is a flowchart illustrating the authentication code generating method in the digital device according to the present invention; and

FIG. 4 illustrates an authentication code generated by the digital device according to the present invention.

### DETAILED DESCRIPTION

Hereinafter, an implementation of a method of generating an authentication code in a digital device according to the present invention will be described in detail with reference to the attached drawings.

According to the present invention, a method of directly generating a unique authentication code in a digital device to maintain the generated authentication code is provided. After the digital device is provided to a user, the authentication code is generated once, and the authentication code is displayed so that the generated authentication code can be utilized.

In order for the authentication code not to be exposed before the digital device is operated and in order for contents not to be utilized by other devices, the authentication code should be directly generated and maintained by the digital device.

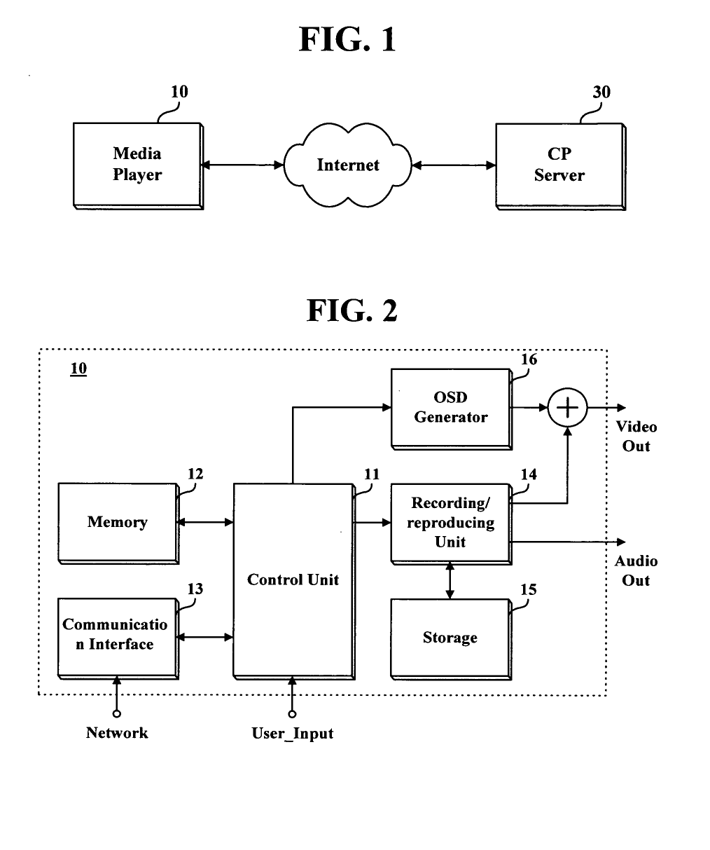

FIG. 1 schematically illustrates the structure of a network system for describing an embodiment in which a digital device according to the present invention is connected to a contents providing server. FIG. 2 is a block diagram schematically illustrating the structure of a digital device to which an authentication code generating method according to the present invention is applied.

The network system of FIG. 1 comprises a digital device 10 which processes contents files requested to be reproduced by a user such as music, moving picture, and data and outputs the signal processed contents files through a speaker and a screen and a contents providing server 30 which stores various digital contents (the music, the moving picture, and the data) files in a database and provides the digital contents to the digital device 10 connected through a network such as the Internet by a streaming or download method.

In addition, the network system can further comprise a personal computer or a notebook (not shown) simultaneously connected to the digital device 10 and the contents providing server 30 through the network to download the contents files requested by the user and to transmit the downloaded contents files to the digital device 10.

As illustrated in FIG. 2, the digital device 10 can comprise a control unit 11, a memory 12, a communication interface 13, a recording/reproducing unit 14, a storage 15, and an OSD generator 16.

The memory 12 stores firmware for managing the entire operation of the digital device 10 and a unique ID (or a fixed ID) having a fixed value provided to the digital device and an authentication code generated in accordance with the present invention. In addition, an algorithm for generating an authentication code using the fixed ID can be included in the firmware managed by the memory. The algorithm is executed by the control unit 11 to generate the authentication code and executed by the control unit 11 or the recording/reproducing unit 14 to decode contents to which the authentication code is added or that is encoded through the authentication code to original contents.

The communication interface 13 serves as a network adaptor directly connected to the contents providing server 30 through the Internet or a communication port such as a universal serial bus (USB) to be connected to a PC or a notebook to transmit and receive data.

The storage 15 is a storage medium such as a flash memory, a hard disk, and an optical disc for storing digital contents. The flash memory or the hard disk can be fixed to the digital device 10 and the flash memory or the optical disc can be attached and detached.

The recording/reproducing unit 14 records the digital contents transmitted through the communication interface 13 in the storage 15 and reads the digital contents stored in the storage 15 to process the digital contents in accordance with the format of the digital contents and to output the processed digital contents as audio and video or an image. When the authentication code is added or encrypted to the contents stored in the storage 15, the encrypted contents can be restored to original contents through a decrypting algorithm.

When the OSD generator 16 generates information or a menu related to the operation of the digital device 10 in the form of a text and an image to output the text or image, the text or image overlaps with the image or video output from the recording/reproducing unit 14 to be output to a screen.

The control unit 11 receives the input of a user to control the elements of the digital device 10. That is, the control unit 11 receives digital contents through the communication interface 13 and controls the recording/reproducing unit 14 to store the transmitted digital contents in the storage 15 or to reproduce and output the digital contents stored in the storage 15.

In addition, the control unit 11 controls the OSD generator 16 to generate the operation state of the digital device or the menu as the text or the image in accordance with the input of the user. Items related to the generation of the authentication code are included in the menu.

In addition, the digital device 10 can further comprise a speaker and/or a screen of an LCD and an OLED for outputting audio and video or an image generated by the recording/reproducing unit 14 and the OSD generator 16.

The digital device 10 can comprise an MP3 player, a PMP, an electronic dictionary, a navigation, and a mobile terminal for reproducing digital contents and the digital device 10 can be a karaoke system for storing data on various songs in a hard disk and/or an optical disc that are fixed storage media and for receiving new songs from the contents providing server to store the received songs.

When an authentication code generating menu is selected by the user, the control unit 11 determines whether an authentication code having a fixed ID identical with the fixed ID set in the digital device 10 exists in the memory 12. When it is determined that the authentication code does not exist, the control unit 11 reads a fixed ID set in the control unit 11 or stored in the memory 12, generates a serial number using the read fixed ID or randomly, combines the generated serial number with the fixed ID to generate an authentication code, outputs the generated authentication code to a screen through the OSD generator 16, and stores the generated authentication code in the memory 12.

In addition, when the authentication code having the fixed ID identical with the fixed ID set in the digital device 10 exists in the memory 12, the control unit 11 reads the authentication code stored in the memory 12 and outputs only the serial number excluding the fixed ID from the read authentication code to the screen through the OSD generator 16.

At this time, the authentication code comprises the fixed ID set during the production of the digital device 10 and the randomly generated serial number or the serial number generated using the fixed ID through an operation of generating the authentication code and only the serial number excluding the fixed ID is output from the authentication code to the screen in order to prevent a surreptitious use.

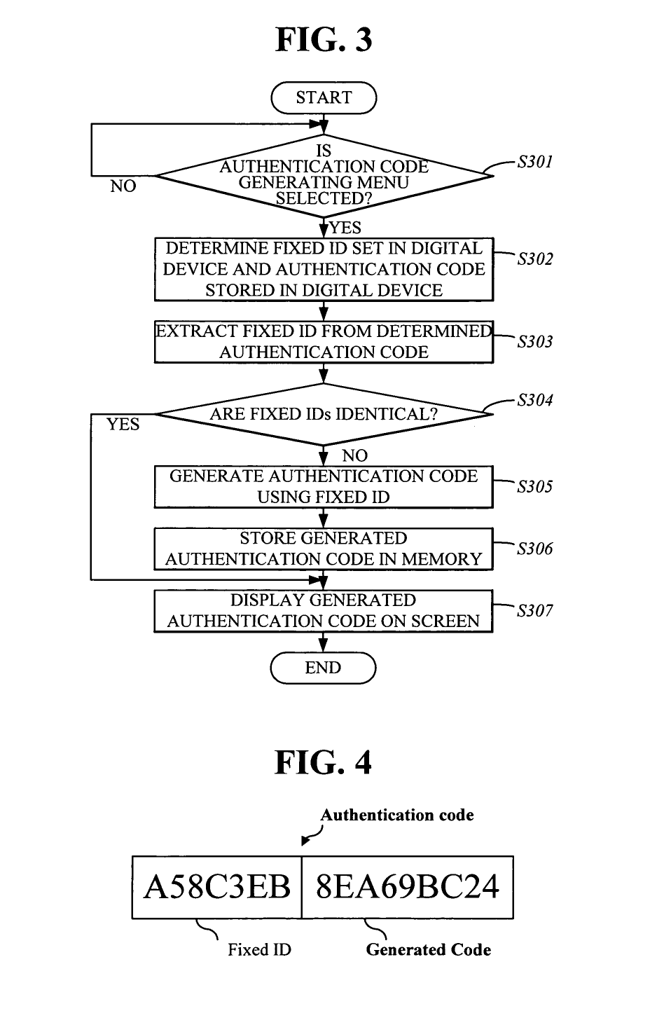

A method of generating an authentication code applied to the above-structured digital device will be described in detail with reference to FIGS. 3 and 4.

FIG. 3 is a flowchart illustrating the authentication code generating method in the digital device according to the present invention. FIG. 4 illustrates an authentication code generated by the digital device according to the present invention.

The digital device 10 according to the present invention is connected to the contents providing server 30 directly through the communication interface 13 or via a host such as a PC or a notebook to download desired digital contents files and to reproduce the downloaded digital contents files.

When an authentication code generating menu is selected by a user (S301), the control unit 11 determines a fixed ID previously set in the memory 12 or in an IC for realizing the operation of the control unit 11 and an authentication code stored in the memory 12 (S302).

When the authentication code is previously generated, the authentication code generated by combining the fixed ID with the serial number generated using the fixed ID is stored in the determined address of the memory 12. When the authentication code is not generated, an arbitrary value is stored in the determined address of the memory 12.

The control unit 11 extracts a fixed ID from the determined authentication code (S303) and compares the extracted fixed ID with a fixed ID set in the digital device 10 to determine whether the extracted fixed ID is identical with the fixed ID set in the digital device 10 (S304).

When the fixed ID extracted from the determined authentication code is not identical with the fixed ID set in the digital device 10, that is, when it is determined that the authentication code is not generated by the digital device 10, the control unit 11 randomly generates a serial number or generates a serial number using the fixed ID determined in S302 and combines the fixed ID with the serial number to generate an authentication code (S305) and to store the generated authentication code in the memory 12 (S306). Here, as illustrated in FIG. 4, the authentication code comprises the fixed ID set when the digital device 10 is produced and the randomly generated serial number or the serial number generated using the fixed ID.

When the authentication code is generated, the control unit 11 outputs the authentication code to a screen through the OSD generator 16 (S307). At this time, only the serial number generated using the fixed ID or only the randomly generated serial number is output to the screen through the OSD generator 16 in order to prevent another person excluding the user or another reproducing device excluding the corresponding digital device 10 from surreptitiously using the authentication code.

In addition, when it is determined in S304 that the fixed ID extracted from the determined authentication code is identical with the fixed ID set in the digital device 10, that is, when it is determined that the authentication code is previously generated by the digital device 10, the authentication code determined in S302 is output to the screen through the OSD generator 16 (S307).

Therefore, it is possible to prevent the digital device 10 from redundantly generating the authentication code and the generated authentication code is displayed on the screen so that the user can use the authentication code.

On the other hand, as described above, when the user connects the digital device 10 to the contents providing server 30 desired by the user through the network such as the Internet using the generated authentication code and buys MP3 files in accordance with the guide of the contents providing server 30, the digital media providing server 30 adds the generated authentication code to the corresponding MP3 files or encrypts the corresponding MP3 files using the authentication code to transmit the encrypted MP3 files and the control unit 11 of the digital device 10 downloads the MP3 files to which the authentication code is added or the encrypted MP3 files and controls the recording/reproducing unit 14 to store the downloaded MP3 files in the storage 15.

Since the MP3 files stored in the storage 15 are encrypted or the authentication code of the user is added to the MP3 files, the MP3 files cannot be reproduced by another digital device excluding the corresponding digital device 10.

In addition, the user of the digital device who cannot directly access the contents providing server 30 through the network such as the Internet can access the contents providing server through a PC or a notebook in order to download the digital contents such as new music, moving picture, and data.

At this time, when the digital contents file such as predetermined music, moving picture, and data is selected by the connected PC, the contents providing server 30 requests the digital device 10 to transmit the authentication code. When the requested authentication code is transmitted, the transmitted authentication code is automatically added to the selected contents file or the contents file is encrypted using the authentication code, and the encrypted contents file is transmitted to the connected PC.

Since after the PC downloads the digital contents file to which the authentication code is added, stores the downloaded digital contents file in the specific directory of a storage medium such as a hard disk and transmits the stored digital contents file to the digital device connected through the communication interface such as the USB or IEEE 1394, the downloaded digital contents file can be reproduced only by the digital device having an identical authentication code.

Therefore, it is possible to prevent the authentication code from being surreptitiously used and to prevent the authentication code from being redundantly provided.

While embodiments of the present invention are described with reference to the accompanying drawings. However, it will be understood by those skilled in the art that various changes in form and details may be made therein without departing from the spirit and scope of the invention.

1. A method of generating an authentication code in a digital device, comprising:
reading an ID set in the digital device if requested to generate an authentication code;
generating the authentication code based on the ID; and
storing the authentication code and displaying a part of the authentication code.

2. The method of claim 1, wherein the authentication code is generated by combining the ID with a serial number generated using the ID.

3. The method of claim 2, wherein the part of the authentication code is the serial number.

4. The method of claim 1, wherein the ID is a unique and fixed value set when the digital device is produced.

5. A method of generating an authentication code in a digital device, comprising:
reading an ID set in the digital device if requested to generate an authentication code;
determining whether the authentication code previously generated based on the ID is stored in the digital device;
generating a new authentication code based on the ID and storing the generated authentication code if the authentication code is not stored; and
displaying a part of the authentication code.

6. The method of claim 5, wherein the authentication code is generated by combining the ID with a serial number generated using the ID.

7. The method of claim 6, wherein the determining comprises:
extracting an ID from an authentication code stored in the digital device; and
determining whether the extracted ID is identical with the read ID.

8. The method of claim 6, wherein the part of the authentication code is the serial number.

9. The method of claim 5, wherein the ID is a unique and fixed value set when the digital device is produced.

10. A digital device, comprising:
a memory for storing an ID set in the digital device and an authentication code; and
a control unit configured to read the ID set in the memory, determine whether the authentication code previously generated based on the ID is stored in the memory, generate a new authentication code based on the ID if the authentication code is not stored, store the generated authentication code in the memory, and control so that a part of the authentication code is displayed on a screen if requested to generate the authentication code.

11. The digital device of claim 10, wherein the control unit is configured to generate a serial number using the ID and combines the ID with the serial number to generate an authentication code.

12. The digital device of claim 11, wherein the control unit is configured to extract the ID from the authentication code stored in the memory, compare the extracted ID with the read ID, and determine that the authentication code is previously generated if the extracted ID is identical with the read ID and that the authentication code is not generated when the extracted ID is not identical with the read ID.

13. The digital device of claim 11, wherein the control unit is configured to control so that only the serial number in the authentication code is displayed.

14. The digital device of claim 10, wherein a unique and fixed value set when the digital device is produced is stored in the memory as the ID.
